(19) United States
(12) Patent Application Publication
(10) Pub. No.: US 2006/0171310 A1
(43) Pub. Date: Aug. 3, 2006

(54) Method and system of consolidating mobile IP messages within a network

(75) Inventors: Mankesh S. Ahluwalia, Hoffman Estates, IL (US); Chandra Warrier, Schaumburg, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Inc.

(21) Appl. No.: 11/050,075

(22) Filed: Feb. 3, 2005

(51) Int. Cl. H04J 3/22; H04L 12/26; H04J 3/16; H04L 1/00

(52) U.S. Cl. 370/229; 370/465

(57) ABSTRACT

A method and system of consolidating mobile IP messages within a network is provided. The method and system applies to the transfer of datagrams between home and foreign agents and mobile IP devices. The system provides for a temporary capture and storage of small non-real-time datagrams within a queue by a home agent or packet data serving node. Upon a queue full condition, the datagrams are consolidated into larger datagrams and transferred from the home agent to a packet data serving node or from a packet data serving node to a home agent. Real-time datagrams can be prioritized higher than non-real-time datagrams and transferred immediately to and from mobile IP devices without queuing. Optionally, a watchdog timer may be employed by the home agent and packet data serving nodes to prompt the assembling and sending of consolidated datagrams to limit latency encountered by a queued data.

### FIELD OF INVENTION

The present invention relates to computer networks, and more particularly, to optimizing data packet transfer between packet data serving nodes and home agents.

### BACKGROUND

Computer networks, such as Ethernet (i.e. Institute for Electrical and Electronics Engineers (IEEE) 802.3 specification), provide for communication between computers and computing devices (e.g., personal computers (PCs), mainframe computers, Personal Digital Assistants (PDAs), certain cellular telephones, etc.). Some networks provide services to devices that are wired to the networks and are reasonably local in proximity to each other (i.e., in the same building, on the same campus, etc.). Such networks are often referred to as Local Area Networks (LANs). Other networks provide services to devices that are wired to a LAN and share some common private interest (i.e., members of the same company, members of the same organization, etc.). Such networks are sometimes referred to as Wide Area Networks (WANs).

To facilitate information exchange among computing devices on dissimilar networks, the Internet Protocol (IP) was developed, standardized and adopted by many organizations desiring to access computing devices on the Internet. IP addresses are assigned to the computing devices and are structured such that part of the assigned address, referred to as the class, can identify a particular organizational entity (e.g., a company) and the remainder of the assigned address, the device ID, can identify an individual device within an organization. Using this method, routing-devices throughout the Internet and LANs can parse the destination address of a message and forward the message toward its destination device. Devices using this method cannot change their IP address at will and still receive messages sent to the prior IP address. Further, devices using this method need to physically remain within the network boundaries of their specific network, identified by the class, unless they re-register and obtain a new IP address from their local area network. Since this is impractical on a regular basis (i.e., re-registering every hour or every minute), the mobility of the device is limited.

To achieve this mobility, computing devices rely on Home Agent (HA) devices and Foreign Agent (FA) devices (i.e., collectively referred to as mobility agents) to help modify the IP addressing scheme and make the device appear to have a static IP address. For more information on Mobile IP, the reader is referred to Request For Comments (RFC) 2002 “IP Mobility Support” and RFC 3344 “IP Mobility Support for IPv4”, both of which are herein incorporated by reference in their entirety, as if fully set forth in this description.

According to mobile IP, within a home network, a home agent maintains a mapping of a static IP address, representing a mobile IP device's home address, to the mobile IP device's current IP address (e.g., care-of-address (CoA)). The home address is a static IP address that all networks may use as a destination address to direct data to the mobile IP device, regardless of the mobile IP device's actual IP address or location. Messages sent to the mobile IP device and received at the home agent are forwarded to the mobile IP device's current address by the home agent. The COA is an IP address that represents the current and actual IP address of the mobile IP device. This actual IP address of a mobile IP device may change, as the mobile IP device moves from network to network. If the mobile IP device is within its home network boundaries, the home address and the care-of-address may be identical. However, if the mobile IP device is a member of the home network and temporarily enters a foreign network, the device temporarily acquires a COA address from foreign network.

On the foreign network, the foreign agent accepts a request for an IP address from the mobile IP device and issues the mobile IP device a temporary IP address to be used as the mobile IP device's care-of-address. The mobile IP device informs the home agent that the mobile IP device is no longer on the home network, that the mobile IP device has a new IP address, and the value of this new address, so that the home agent may associate the new IP address with the mobile device's home IP address and forward messages to the mobile IP device.

The home agent associates (i.e., binds) the temporary foreign address with the mobile device's home address. This allows devices on all networks to reference the mobile IP device by the static home address, and also allows the mobile IP device to acquire a new IP address without re-registering with a network.

In a similar manner, all data transmitted by the mobile IP device appears to emanate from the home address. The mobile IP device sends data via the foreign agent to the home agent, and optionally through a secure tunnel. The home agent then re-addresses the data with the static home address of the mobile IP device and forwards the message to the destination device.

Many mobile IP devices have wireless connections. To gain access to a wired IP network, a mobile IP device first connects to a wireless network, which is often referred to as a Radio Access Network (RAN). The mobile IP device may then begin the registration process by sending a request to the Packet Data Serving Node (PDSN), via the radio access network, to obtain a connection on the wired network.

The packet data serving node interfaces the wired network to the wireless network. Upon receiving a registration request from a mobile IP device, the packet data serving node contacts the Authentication, Access, and Accounting (AAA) server for the network to perform mobile IP device registration.

After the registration process is complete, a mobile IP device may begin communication within a network. For example, in a network such as, but not limited to, a Code Division Multiple Access (CDMA) 2000 voice/data network, both voice telephony datagrams and application data (i.e., e-mail, Internet browser data, etc.) are present. Both types of data are routed to and from the mobile IP devices as described above. Voice datagrams are classified as real-time data. That is, an entire series of voice datagrams representing a voice telephony message should be received at its destination without significant delay between datagrams. Any delays or latencies between voice telephony datagrams may degrade the quality of a reassembled analog voice message.

Application datagrams, such as those for e-mail and Internet browsing, are generally considered non-real-time. That is, delays and latencies can be accommodated and accepted between datagrams of a data stream of these types without degradation of their application.

Voice telephony datagrams can be approximately 2048 bytes long, and each datagram typically has a 16-byte long header and a 2032-byte data payload. Thus, the payload-to-header ratio for voice telephony datagrams is approximately 127:1, indicating a large payload-to-header ratio. Application datagrams are approximately 128-bytes long. Each datagram has a 16-byte header and a 112-byte data payload. Thus, the payload-to-header ratio for application datagrams is approximately 7:1, indicating a small payload-to-header ratio.

Header data in a datagram provides no transfer of information. The header serves mainly to assist transportation of the data payload portion of the datagram from its source to destination, in a secure, accurate and sequential order. All datagrams transmitted over the network consume a portion of the available network bandwidth, but the headers do not contribute to information exchange. Headers may be viewed as overhead to the network. Any overhead may be considered wasted bandwidth, as it carries no information.

The payload-to-header ratios indicate that for a series of several datagrams having a small payload-to-header ratio, less information is exchanged, and thus more network bandwidth is used than would be with a single larger datagram. Therefore, it would be desirable to increase the payload size of all datagrams to increase available network bandwidth.

To do so, a series of smaller datagrams can be collected and consolidated into a larger datagram, and then sent at some time later. While this may be acceptable for non-real-time datagrams, it may be unacceptable for real-time datagrams that cannot endure any significant delays. However, in a system, such as a CDMA 2000 system, it may be desirable to reduce all possible overhead to provide more system bandwidth for actual data payload transportation. The reduction of selected non-real-time header data offers one method of overhead data reduction.

### SUMMARY

Within disclosed embodiments, a system and method is presented that may increase IP network bandwidth for mobile IP devices within its network by decreasing the number of smaller, non-real-time datagrams transmitted between the packet data serving node and the home agent. Smaller datagrams traveling from the home agent to the packet data serving node are temporarily removed from the network and queued in a home agent queue until a home agent queue limit is reached, for example. A group of smaller datagrams can be retrieved from the home agent queue, assembled into a single larger payload and inserted into a single datagram that has a single header. The single datagram is then sent by the home agent to the packet data serving node, which disassembles the datagram into the original smaller datagrams, and routes the smaller datagrams to their destinations.

In the reverse direction, the packet data serving node queues, collects, and assembles smaller datagrams into larger datagrams to be sent to the home agent, which disassembles the larger datagrams into original smaller datagrams and routes the original smaller datagrams to their destinations, for example.

Additionally, within disclosed embodiments, a watchdog timer may be used by the home agent and the packet data serving nodes when assembling larger single datagrams to limit the amount of time any one of the smaller datagrams may remain in the queue. Upon expiration of the timer, the queued datagrams can be formatted into larger datagrams and sent to a receiving device in the same manner as when the queues fill, for example.

These as well as other features, advantages and alternatives will become apparent to those of ordinary skill in the art by reading the following detailed description, with appropriate reference to the accompanying drawings.

### BRIEF DESCRIPTION OF FIGURES

FIG. 1 illustrates one example of an IP system according to exemplary embodiments.

FIG. 2 is a detailed block diagram illustrating one embodiment of a home network.

FIG. 3 is a detailed block diagram illustrating one embodiment of a foreign network 6.

FIG. 4 is a block diagram illustrating one embodiment of a home agent.

FIG. 5 is a detailed block diagram illustrating one embodiment of a packet data serving node.

FIG. 6 conceptually illustrates embodiments of formats for a session message, a group of non-real-time messages to be consolidated, a consolidated message, and a consolidation header used by the home agent and the packet data serving node according to exemplary embodiments.

FIG. 7 is a flowchart illustrating one embodiment of a set of messages sent within a system according to exemplary embodiments.

FIG. 8 is a flowchart illustrating another embodiment of a set of messages sent within a system according to exemplary embodiments.

FIG. 9 is a flowchart illustrating another embodiment of a set of messages sent within a system according to exemplary embodiments.

FIG. 10 is a flowchart illustrating another embodiment of a set of messages sent within a system according to exemplary embodiments.

### DETAILED DESCRIPTION

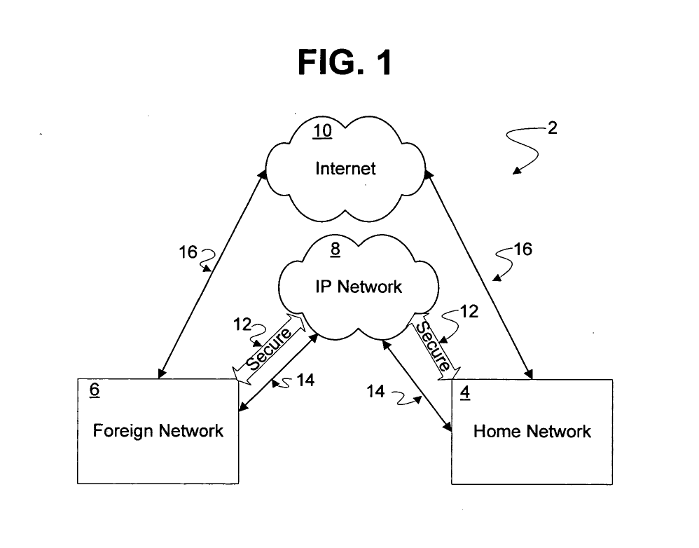

FIG. 1 illustrates one example of an IP system 2 according to exemplary embodiments. The system may be a CDMA2000 system, but other systems may also employ present embodiments. The system 2 includes a home network 4, which maintains static IP addresses of mobile devices. The system 2 also contains a foreign network 6, which provides mobile devices, such as, but not limited to, laptop computers, personal digital assistants (PDAs), CDMA/IP capable mobile phones etc., a temporary IP address when the mobile IP device is connected to the foreign network 6.

The home network 4 connects to the foreign network 6 via a private IP network 8, which is unconnected to the Internet 10, using a private secure and encrypted first network 12 or a non-secure private second network 14. By using the private IP network 8 instead of the public Internet 10, the service providers may control datagram latency and guarantee timely delivery of datagrams to their destinations. Some applications, such as but not limited to, email and Internet browsing, may require a connection to the Internet 10. Thus, both the home network 4 and the foreign network 6 have connections to the Internet 10, such as the third network 16, for this purpose. This third network 16 is shown as a non-secure connection, but other connections, such as, but not limited to, a secure connection, and encrypted connection can be used without affecting present embodiments.

The system 2 illustrated in FIG. 1 may represent one of many systems. For example, the system 2 may represent a mobile IP network, a wide area network (WAN), or a local are network (LAN), for example.

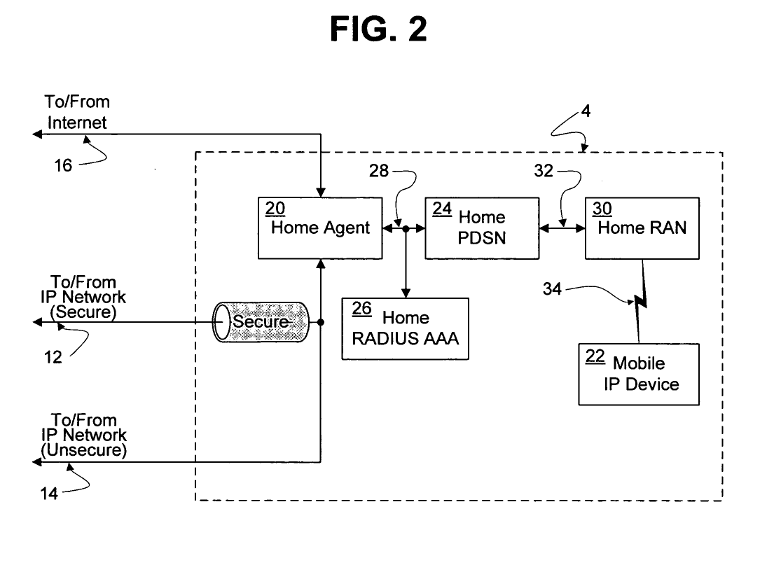

FIG. 2 is a detailed block diagram illustrating one embodiment of the home network 4. A mobility agent, such as a home agent 20, is shown that maintains static IP addresses for mobile IP devices, such as a mobile IP device 22. The home agent 20 also provides a connection to the IP network 8 via the secure first network 12 and the non-secure second network 14. The home network 4 also includes a Packet data serving node (Home PDSN) 24, and a Home Remote Access Dial-In User Service (Home RADIUS) Authentication, Authorization and Accounting (AAA) server 26 interconnected via a first local home network 28. The home network 4 further includes a home Radio Access Network (RAN) 30 through which mobile IP devices connect to the home network 4. The home radio access network 30 serves to interface the mobile IP device 22 to the packet data serving node 24 across a second local home network 32. The mobile IP device 22 connects to the home radio access network 30 across a home wireless radio link 34.

The home RADIUS AAA server 26 may authenticate (i.e., ensure that a mobile IP device is genuinely the device it claims to be) new mobile IP devices entering the IP network 8 via the home radio access network 30; provide access control (i.e., limit file access, limit disk space, etc.); and capture accounting information (i.e., measure the length of time a mobile IP device is present on the network, measure the quantity of data transferred on the network by a mobile IP device, measure the throughput rate of a mobile IP device, log the telephone numbers called by a mobile IP device, etc.) for the mobile IP device 22, for example.

The packet data serving node 24 performs as a gateway to the Internet 10 for mobile IP devices via connection 16 and as a mobility agent for devices connecting through the home RAN 30. Connection 16 is shown as a non-secure connection, but other connections, such as, but not limited to, a secure connection, and encrypted connection etc., could be used according to other embodiments.

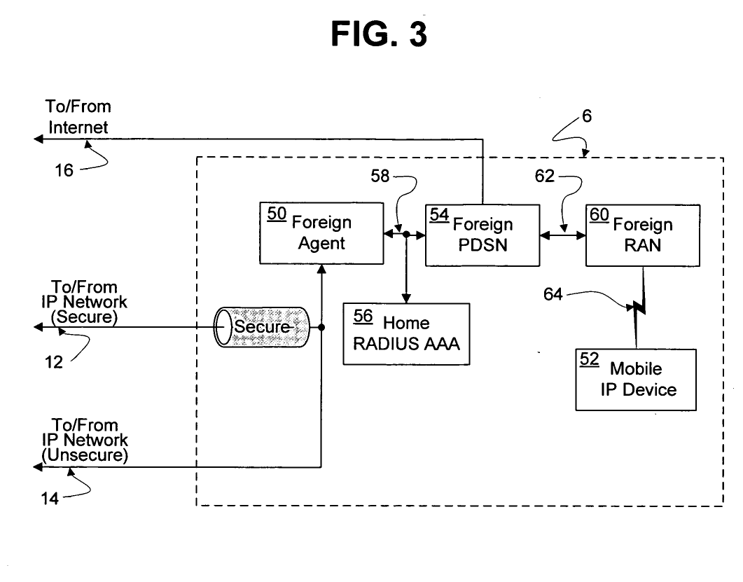

FIG. 3 illustrates a detailed block diagram of one embodiment of the foreign network 6. A foreign agent 50, is shown that provides temporary IP addresses for non-resident mobile IP devices, to transfer data to and from a mobile IP device, such as mobile IP device 52. The foreign agent 50 also provides a connection to the IP network 8 via the secure first network 12 and the non-secure second network 14. The foreign network 6 also includes a Foreign Packet Data Serving Node (Foreign PDSN) 54, and a Foreign Remote Access Dial-In User Service (Foreign RADIUS) Authentication, Authorization and Accounting (AAA) server 56 interconnected via a first local foreign network 58. The foreign network 6 further includes a foreign radio access network 60 that serves to interface the mobile IP device 52 to the foreign packet data serving node 54 across a second local foreign network 62. The mobile IP device 22 connects to the foreign radio access network 60 across a home wireless radio link 64.

The foreign RADIUS AAA server 56 may authenticate foreign mobile IP devices entering the foreign network 6 via the foreign radio access network 60, provide access control, and capture accounting information for the foreign mobile IP device 52, for example.

The foreign packet data serving node 54 performs as a gateway to the Internet 10 for mobile IP devices via the connection 16 and to the private networks through the foreign agent 50 for devices connecting through the foreign radio access network 60. Connection 16 is shown as a non-secure connection, but other connections, such as, but not limited to, a secure connection, and encrypted connection etc., could be used in other embodiments.

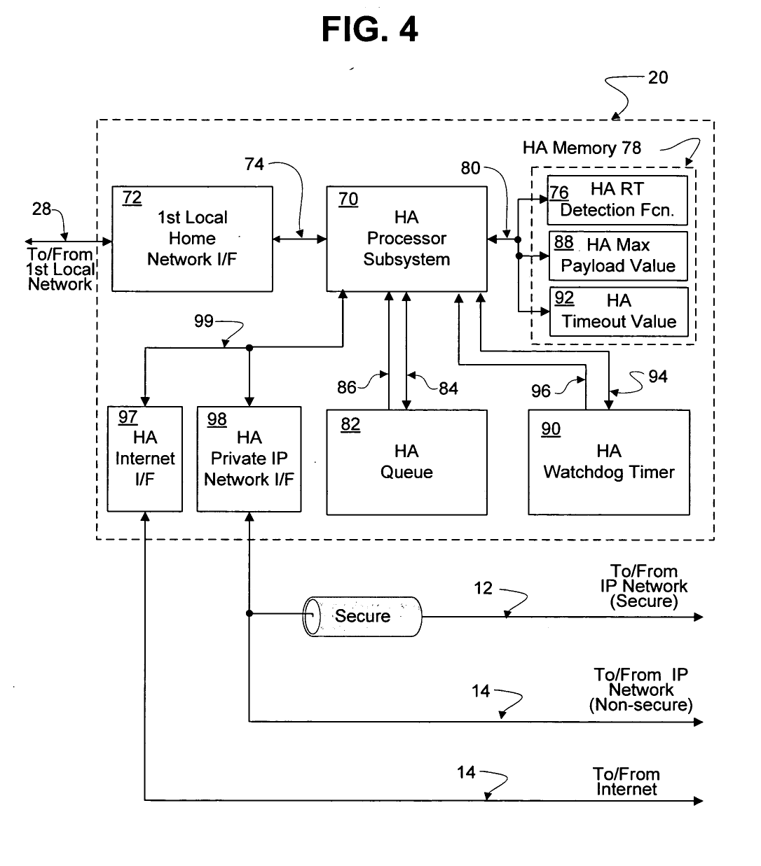

FIG. 4 is a block diagram illustrating one embodiment of the home agent 20. The home agent 20 includes a home agent processor subsystem 70 that manages data entering or exiting the home agent 20, as well as controls functionality of the home agent 20, such as assigning IP addresses to mobile devices and forwarding data to mobile IP devices currently present on foreign networks. The home agent processor subsystem 70 connects to a first local interface 72 across a first home agent network 74. Data sent to or from devices on the first local home network 74 leaves and enters the home agent 20 via the first home agent network interface 72.

When performing as a first mobility agent, the home agent 20 transfers messages received from the Internet 10 or the private IP network 8 to a second mobility node, such as the packet data serving node 34. When the home agent processor subsystem 70 receives a message from the mobile IP device 22 for a given session via the first home network interface 72, the home agent processor subsystem 70 first determines if the message is a Real-Time (RT) message or a Non-Real-time (NRT) message. For example, the home agent processor subsystem 70 can execute a home agent real-time data detection function 76 within home agent memory 78 using a second home agent network 80. If the received message contains real-time-data, the message is forwarded to its destination; however, if the message contains non-real-time data, the message is temporarily stored in a home agent queue 82 by the home agent processor subsystem 70 over a third home agent network 84.

The home agent processor subsystem 70 can distinguish between real-time and non-real-time messages by looking at headers of the messages and identifying a protocol within the messages. For example, messages including RTP headers would be considered real-time messages, and a message including a TCP header and directed toward port 23 would be considered a non-real-time message. Other examples are possible as well. In general, the subsystem 70 reads headers of received messages to determine if the message is a real-time message or a non-real-time message.

The home agent processor subsystem 70 can also distinguish messages based on many other types of prioritization methods as well. For example, certain customers may subscribe to a premium service so that messages sent and received by these customers are directly sent to their destination without any temporarily holding or storage. Other examples are possible as well. Within these examples, the subsystem 70 can read headers of received messages to determine whether to forward the message to its destination or to temporarily store the message in the queue 82.

The home agent queue 82 may hold 1024-messages for the system 2. However, the queue 82 may be designed to hold other quantities of messages before becoming full, such as 256- or 512-messages, for example. When the home agent queue 82 is filled with 1024-messages, a home agent queue full signal 86 is sent to alert the home agent processor subsystem 70 of the queue full condition.

Upon receipt of the home agent queue full signal 86, the home agent processor subsystem 70 retrieves the non-real-time session messages from the queue, consolidates the messages into larger consolidated payloads, and formats a proprietary message containing the consolidated payloads to their destination (described more fully below). A maximum size of the proprietary message, e.g., 1024-bytes for the system 2, is determined by a home agent maximum payload value 88, which is stored in the home agent memory 78 and retrieved by the home agent processor subsystem 70 over the second home agent network 80. Although the home agent maximum payload value 88 is 1024-bytes for this example, other values may also be used, such as 512- or 256-bytes.

The home agent 20 further includes a home agent watchdog timer 90 that is accessible to the home agent processor subsystem 70 via a fourth home agent network 94. Upon receipt of the first non-real-time data message subsequent to the home agent queue 82 being empty, the home agent processor subsystem 70 retrieves a home agent timeout value 92 from the home agent memory 78 across the second home agent network 80. The home agent processor subsystem 70 utilizes the home agent timeout value 92 to program the home agent watchdog timer 90 to expire at a time equal to the value of the home agent timeout value 92. The home agent watchdog timer 90 prevents a plurality of non-real time messages (the total number of messages being less than the capacity of the home agent queue 82 (i.e. 1024 messages for this example)) from remaining in the home agent queue 82 for an excessively long time, and encountering a large delay before being transmitted. The maximum duration of allowable delay is specified by the home agent timeout value 94, which may be 500 mS, for example. The home agent timeout value 92 may alternatively be 1000 mS, 200 mS or other values as well.

The home agent processor subsystem 70 starts the home agent watchdog timer 90 to time an event by issuing to the home agent watchdog timer 90 a “Start Timing” command over the fourth home agent network 94. The “Start Timing” command is issued to the home agent watchdog timer 90 when the first non-real time message is stored in the home agent queue 82 by the home agent processor system 70 subsequent to the home agent queue 82 being empty. Upon expiration of the home agent watchdog timer 90, a watchdog timer expired signal 96 is sent to the home agent processor subsystem 70 to alert the home agent processor subsystem 70 that the end of the timed event has occurred. The home agent processor subsystem 70 then disables the home agent watchdog timer 90 by issuing a “Disable Timer” command over the fourth home agent network 94 to the watchdog timer 90. The home agent processor subsystem 70 then retrieves the messages from the home agent queue 82, consolidates the plurality of messages into larger payloads, and sends proprietary messages containing the consolidated payloads to their destinations.

The home agent 20 may also perform as a second mobility agent when receiving messages from the packet data serving node 34. For example, upon receiving a message containing a consolidated payload across the first local home network interface 72, the home agent processor subsystem 70 extracts the consolidated payload from the message. The home agent processor 70 then parses the consolidated payload to identify and separate each individual message. Each individual message is then forwarded to its destination, as specified by its IP header. The home agent processor subsystem 70 connects to a home agent Internet interface 97 to allow the home agent 20 to transfer messages across the third network 16 to the Internet 10 via a fifth home agent network 99. The home agent processor subsystem 70 also connects to a home agent private IP network interface 98 across the fifth home agent network 99.

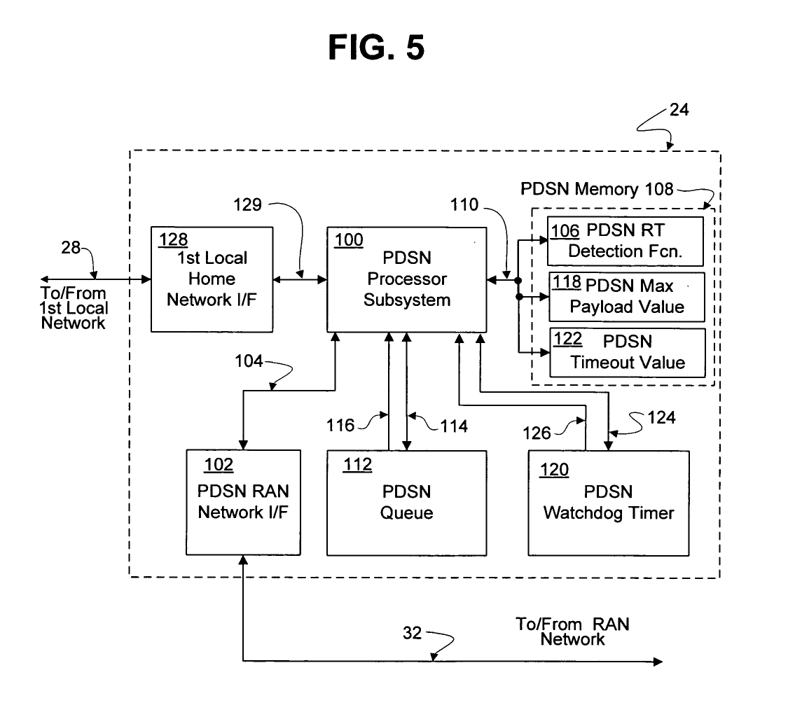

FIG. 5 is a detailed block diagram illustrating one embodiment of the packet data serving node 24. The packet data serving node 24 includes a packet data serving node processor subsystem 100 that manages data entering or exiting the packet data serving node 24, as well as controls functionality of the packet data serving node 24, such as transferring data to and from the home radio access network 30 and forwarding data to the home agent 20. The packet data serving node processor subsystem 100 connects to a radio access network interface 102 across a first network 104. Data being sent to or from devices present on the radio access network 30 leaves and enters the packet data serving node 24 via the packet data serving node radio access network interface 102.

When performing as a first mobility node, the packet data serving node 24 first transfers messages received from the mobile IP device 22 to a second mobility node, such as the home agent 34. When the packet data serving node processor subsystem 100 receives a message from the mobile IP device 22 via the radio access network interface 102, the packet data serving node processor 100 first determines if the message is a Real-Time (RT) message or a Non-Real-time (NRT) message. The packet data serving node processor subsystem 100 retrieves a detection function 106 from memory 108 across a second packet data serving node network 110. If the received message contains real-time-data, the message is forwarded to its destination. However, if the message contains non-real-time data, the message is temporarily stored in a queue 112 by the packet data serving node processor subsystem 100 over a third packet data serving node network 114.

The packet data serving node processor subsystem 100 can distinguish between real-time and non-real-time messages in a manner similar to the subsystem 70 in the home agent 20. For example, the packet data serving node processor subsystem 100 can look at headers of the messages and identify a protocol within the messages to determine if the message is a real-time message or a non-real-time message.

The packet data serving node queue 112 holds 1024-messages for the system 2; however, the queue may be designed to hold other quantities of messages before becoming full, such as 256- or 512-messages, for example. When the packet data serving node queue 112 is filled with 1024-messages, a queue full signal 116 is sent to alert the packet data serving node processor subsystem 100 of the queue full condition.

Upon receipt of the queue full signal 116, the packet data serving node processor subsystem 100 retrieves the stored messages from the queue 112, consolidates the messages into larger consolidated payloads, and formats proprietary messages containing the consolidated payloads. A maximum size (i.e., 1024-bytes for the system 2) of the larger payloads is determined by a maximum payload value 118, which is stored in the memory 108 and retrieved by the packet data serving node processor subsystem 100 over a second packet data serving node network 110.

A packet data serving node watchdog timer 120 is accessible to the packet data serving node processor subsystem 100 via a fourth packet data serving node network 122. Upon receipt of the first non-real-time data message (when the packet data serving node queue 112 is empty), the packet data serving node processor subsystem 100 retrieves a packet data serving node timeout value 122 from the memory 108 across the second network 110. The packet data serving node processor subsystem 100 uses the packet data serving node timeout value 122 to program the packet data serving node watchdog timer 120 across a fourth network 124 to expire at a time equal to the value of the packet data serving node timeout value 122. The packet data serving node watchdog timer 120 prevents one or more non-real time messages from remaining in the packet data serving node queue 112 for an excessively long time, and thus encountering a large delay before being transmitted. A maximum duration of allowable delay is specified by the packet data serving node timeout value 124, which may be 500 mS, for example. However, the packet data serving node timeout value 122 may be other values, such as 1000 mS or 200 mS, for example.

The packet data serving node watchdog timer 120 is programmed with the packet data serving node timeout value 122 by the packet data serving node processor subsystem 100 over the fourth packet data serving node network 124. The packet data serving node processor subsystem 100 subsequently starts the packet data serving node watchdog timer 120 to time an event by issuing the packet data serving node watchdog timer 120 a “Start Timing” command over the fourth packet data serving node network 124. The “Start Timing” command is issued to the packet data serving node watchdog timer 120 when the first non-real time message is stored in the packet data serving node queue 110 when the queue 112 is empty. Upon expiration of the packet data serving node watchdog timer 120, a signal 126 is sent to the packet data serving node processor subsystem 100 to alert the packet data serving node processor subsystem 100 that the end of the timed event has occurred. The packet data serving node processor subsystem 100 then disables the packet data serving node watchdog timer 120 by issuing a “Disable Timer” command over the fourth packet data serving node network 124. The packet data serving node processor subsystem 100 then retrieves the messages from the packet data serving node queue 112, consolidates the messages into larger consolidated payloads, and formats and sends proprietary messages containing the consolidated payloads to their destinations. The packet data serving node processor subsystem 100 connects to a first local home network interface 128 across a fifth packet data serving node network 129 to transfer messages to the local network.

The packet data serving node 24 may also perform as a second mobility agent when receiving messages from a first mobility agent, such as the home agent 20. Upon receiving a message containing a consolidated payload across the first local home network interface 128, the packet data serving node processor subsystem 100 extracts the consolidated payload from the message. The packet data serving node processor 100 then parses the consolidated payload to identify and separate each individual message. Each individual message is then forwarded across the radio access network 30 to its destination, as specified by an IP header in the message, for example.

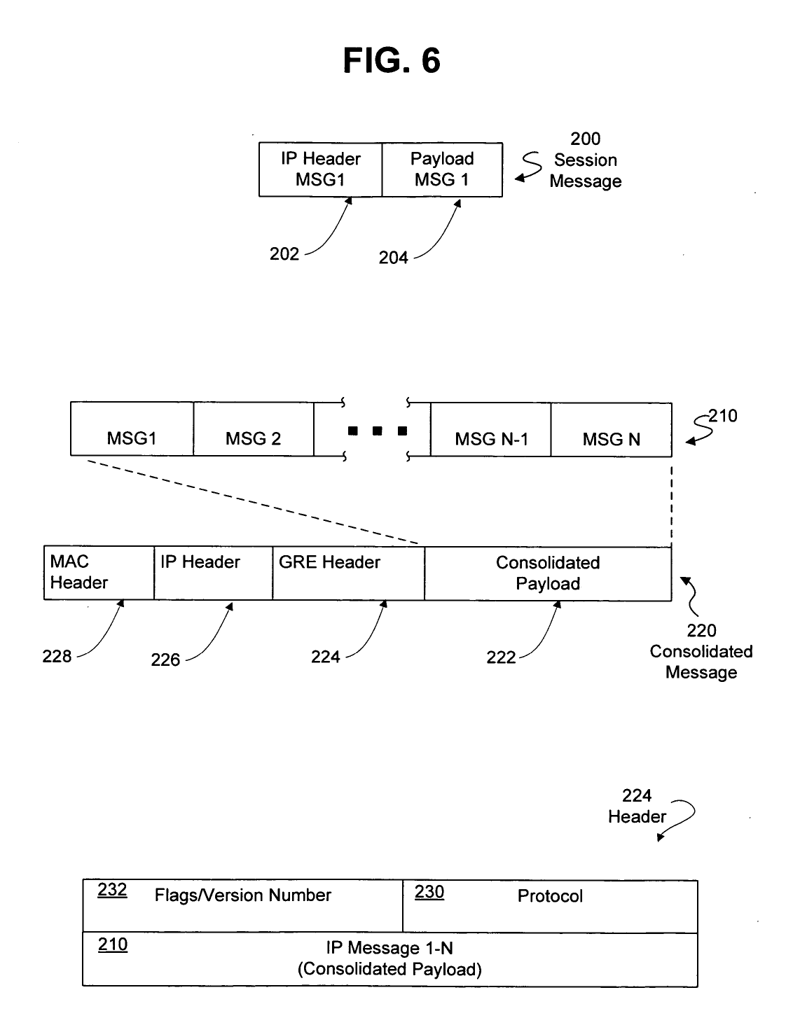

FIG. 6 conceptually illustrates embodiments of formats for a session message 200, a group of non-real-time messages to be consolidated 210, a consolidated message 220, and a consolidation header, such as a General Routing Encapsulation 224 header, used by the home agent 20 and the packet data serving node 24 according to exemplary embodiments. Each session message (i.e., MSG 1 through MSG N) 200 includes an IP header 202 and a session message payload 204. The IP header 202 includes a source IP address that indicates the device to which the session message 200 is directed, and a destination IP address that indicates the device that the session message 200 was sent from. For more information regarding the details of IP header format, see Request for Comments 791 “Internet Protocol”, which is herein incorporated by reference in its entirety. The message payload 204 includes session specific data to be transferred from the IP source address to the IP destination address.

The group of session messages 210 is shown to include “N” session messages 200. The group of session messages 210 is concatenated to form a consolidated payload 222 within the consolidated message 220. A maximum size of the consolidated payload 222 is determined by the value of the home agent maximum payload value 88 for the home agent 20, and the packet data serving node maximum payload value 118 for the packet data serving node 24. For this example, both values are 1024-bytes.

Thus, to form the consolidated payload 222, the home agent processor subsystem 70 retrieves session messages 200 from the home agent queue 82, such that the total number of all bytes of all retrieved session messages 200 is less than or equal to the home agent maximum payload value 88 (e.g., 1024-bytes), and concatenates the session messages 200 into a consolidated payload 220. The home agent 20 then prepends the General Routing Encapsulation (GRE) 224 header to the consolidated payload 222. An IP header 226 containing the address of the packet data serving node 24 (i.e. the IP destination address), followed by a Media Access Control (MAC) header 228 are then prepended to the GRE header 224. When formatting the general routing encapsulation header 224, the home agent processor subsystem 70 identifies the message as a consolidated message 220. The home agent processor subsystem 70 sets a Protocol Type field 226 of the general routing encapsulation header 224 to a unique proprietary value, such as A000 hexadecimal (i.e., 40960 decimal), for example. The Protocol Type field 226 may alternatively be B000 hexadecimal (e.g., 45056 decimal), or any other value that does not conflict with other values currently in use. For a list of values currently in use, the reader is referred to values referred to as “ETHER TYPES” that are distributed by the International Corporation for Assigned Names and Numbers (ICANN). The protocol type field can be set to other values as well. The other fields of the general routing encapsulation header 224, such as a protocol field 230 and a Flags/Version Number 232 field, are defined in the Request For Comments 2784 “Generic Routing Encapsulation”, which is herein incorporated by reference in its entirety.

The packet data serving node 24 forms the consolidated payload 222, in a manner similar to the home agent 20. The packet data serving node 24 extracts session messages 200 from the packet data serving node queue 112, and concatenates the session messages 200 into a consolidated payload 222. The packet data serving node 24 then prepends the General Routing Encapsulation (GRE) 224 header, to the consolidated payload 222 and sends the consolidated message to its destination, for example.

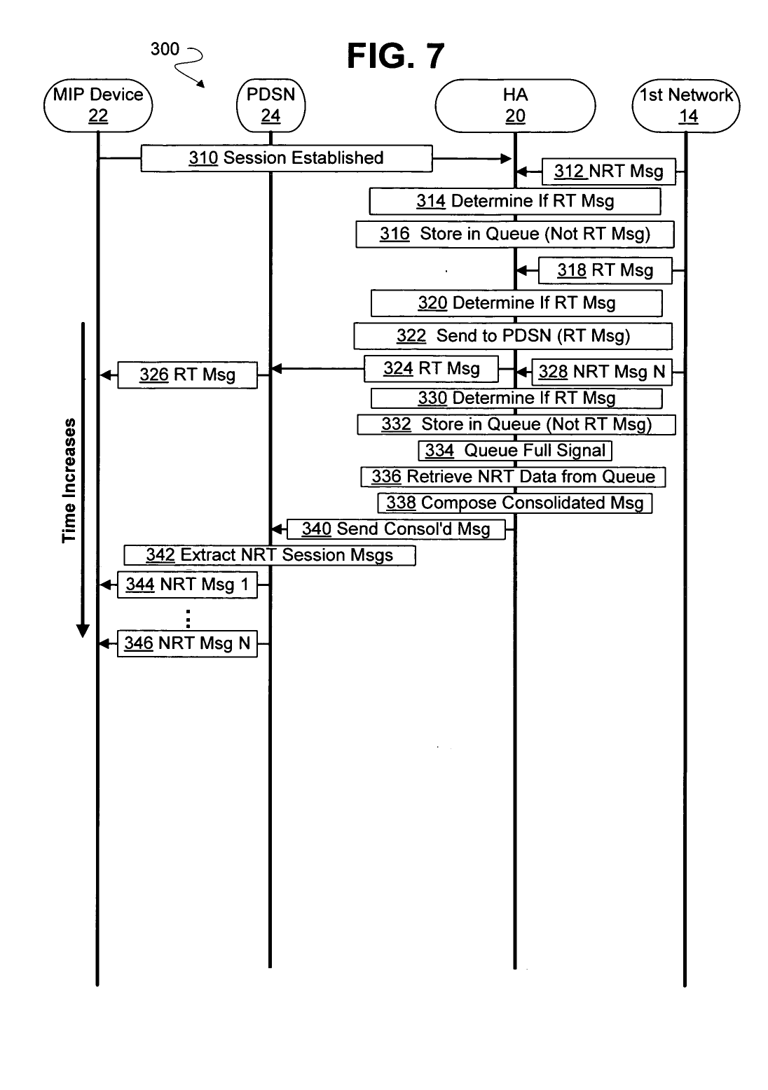

FIG. 7 is a flowchart 300 illustrating one embodiment of a set of messages sent within the system 2 according to exemplary embodiments. Initially, the mobile IP device 22 establishes a session through the packet data serving node 24 to the home agent 20, as shown in step 310. Subsequently, a non-real-time message arrives at the home agent 20 for the mobile IP device 22 from the non-secure private IP network 14, as shown in step 312. The home agent processor subsystem 70 receives the message from the private IP network 8 through the home agent private network interface 97 via the fifth home agent network 99. The home agent processor subsystem 70 then determines if the message is a real-time message or non-real-time message, as shown in step 314. Since the message 312 is a non-real-time message, the home agent processor subsystem 70 stores the message in the home agent queue 82. For this example, the home agent queue holds 1024-messages, and the message stored in step 316 is the 1023rd message stored in the home agent queue 82.

Later, a real-time data message arrives in the home agent 20 via the non-secure private IP network 14 from the private IP network 8, as shown in step 318. The home agent processor subsystem 70 receives the message through the home agent private IP network interface 98 across the fourth home agent network 99 and determines if the message is a real-time message or not, as shown in step 320. Since the message is a real-time message, the home agent processor subsystem 70 will send the message to the packet data serving node 24, as shown in step 322. The home agent processor subsystem 70 sends the real-time message to the packet data serving node 24 as shown in step 324. The packet data serving node 24 forwards the message 324 to the mobile IP device 22 through the home radio access network 30 and along the home wireless radio link 34, as shown in step 326.

Another non-real-time message is received by the home agent 20 from the non-secure private IP network 14, as shown in step 328. The home agent processor subsystem 70 receives the message and determines if the message is a real-time message or non-real-time message, as shown in step 330. Since the message 328 is a non-real-time message, the home agent processor subsystem 70 stores the message in the home agent queue 82. The message 328 is the 1024th non-real-time message stored in the home agent queue 82. Consequently, the home agent queue 82 is now full. The home agent queue 82 alerts the home agent processor subsystem 70 of the queue full condition via the home agent queue full signal 86, as shown in step 334.

The home agent processor subsystem 70 retrieves messages from the home agent queue 82 in a first-in-first-out manner (i.e., the oldest message stored is retrieved first, then the second oldest message stored is retrieved, etc.) as shown in step 336. The home agent processor subsystem 70 also retrieves the home agent maximum payload value 88 from the home agent memory 78 and composes a consolidated message 220, as shown in step 338, ensuring that the consolidated payload 222 does not exceed the size specified by the home agent maximum payload value 88. For this example, the home agent maximum payload value 88 is 1024-bytes. The consolidated message is addressed to the packet data serving node 24 and sent across the first home agent network 74 via the first local home network interface 72 and onto the first local home network 28, as shown in step 340. The home agent processor subsystem 70 repeats the extracting step, composing step, and sending step until the home agent queue 82 is empty.

The message from step 340 will arrive at the packet data serving node first local network interface 128 from the first local home network 28. The packet data serving node processor system 100 retrieves the messages from the packet data serving node first local network interface 128 across the fifth packet data serving node network 129. The packet data serving node 24 then extracts the individual session messages from the consolidated payload 222 of the consolidated message 220. The packet data serving node processor subsystem 100 sends the extracted messages (e.g., messages 1 through N) to the mobile IP device 22 as shown in step 344 and step 346. Each consolidated message 220 received by the packet data serving node 24 is processed in this manner.

Within the example described in FIG. 7, the non-real-time messages are each assumed to be small enough such that the messages can be stored in the home agent queue 82 without filling up the queue themselves. However, since the queue of packets is emptied based on number of bytes or stored packets, if the total length of all the packets in the queue reach a certain limit, then the packets are bundled and sent. As a result, if a single non-real-time packet is large enough, the packet may not be stored at all, and may just be sent immediately, for example.

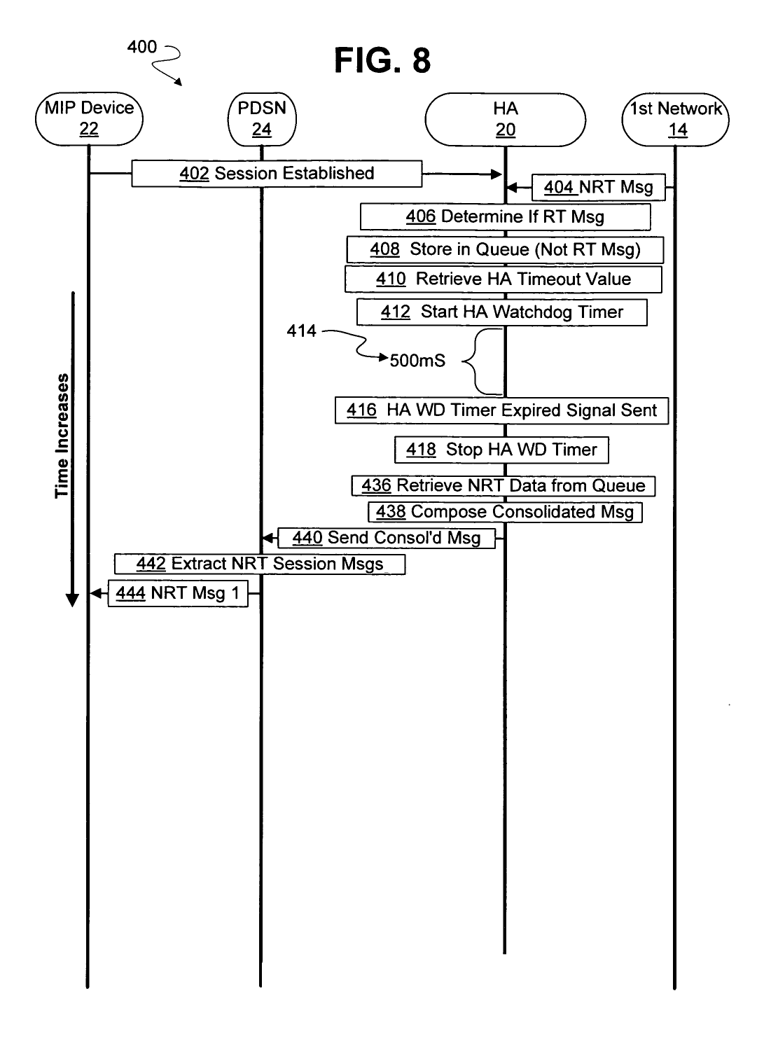

FIG. 8 is a flowchart 400 illustrating another embodiment of messages sent within the system 2. Again, initially, the mobile IP device 22 establishes a session through the packet data serving node 24 to the home agent 20, as shown in step 402. The home agent queue 82 currently contains no messages. Subsequently, a non-real-time message arrives at the home agent 20 for the mobile IP device 22 from the non-secure private IP network 14, as shown in step 404. The home agent processor subsystem 70 receives the message and determines if the message is a real-time message or non-real-time message, as shown in step 406. Since the message 404 is a non-real-time message, the home agent processor subsystem 70 stores the message in the home agent queue 82. For this example, the home agent queue holds 1024-messages, and the message stored in step 408 is the first message stored in the home agent queue 82. Since this is the first message stored in an empty queue, the home agent processor subsystem 70 retrieves the home agent timeout value 92 from the home agent memory 78, as shown in step 410. The home agent processor subsystem 70 programs the home agent watchdog timer 90 with the timeout value by sending the home agent watchdog timer 90 the value over the fourth home agent network 94. The home agent processor subsystem 70 also commands the home agent watchdog timer 90 to begin timing by sending a “Start Timing” command over the fourth home agent network 94, as shown in step 412. Here, the home agent watchdog timer 90 begins timing a 500 mS event, for example.

At a time 500 mS later, the home agent watchdog timer 90 expires and the watchdog sends the home agent watchdog timer expired signal 96 to the home agent processor subsystem 70, as shown in step 416. The home agent processor subsystem 70 sends the home agent watchdog timer 90 a “Stop Timing” command over the fourth home agent network 94 to cause the home agent watchdog timer 90 to halt operation, as shown in step 418.

The home agent processor subsystem 70 then extracts messages from the home agent queue 82 in a first-in-first-out manner, as shown in step 436. In this example, there is only one message in the home agent queue 82. The home agent processor subsystem 70 also retrieves the home agent maximum payload value 88 from the home agent memory 78 across the second home agent network 80 and composes a consolidated message 220, as shown in step 438, ensuring that the consolidated payload 222 does not exceed the size specified by the home agent maximum payload value 88. For this example, the home agent maximum payload value 88 is 1024-bytes. The consolidated message is addressed to the packet data serving node 24 and sent across the first home agent network 74 via the first local home network interface 72 and onto the first local home network 28, as shown in step 440. The home agent processor subsystem 70 repeats the extracting step 436, composing step 438, and sending consolidated messages step 440 until the home agent queue 82 is empty.

The message from step 440 arrives at the packet data serving node first local network interface 128 from the first local home network 28. The packet data serving node processor system 100 retrieves the messages from the packet data serving node first local network interface 128 across the fifth packet data serving node network 129. The packet data serving node 24 then extracts the individual session messages from the consolidated payload 222 of the consolidated message 220. For this example, there is only one message to extract. The packet data serving node processor subsystem 100 sends the extracted message (i.e., message 1) to the mobile IP device 22, as shown in step 444. Each such consolidated message 220 received by the packet data serving node 24 is processed in a similar manner.

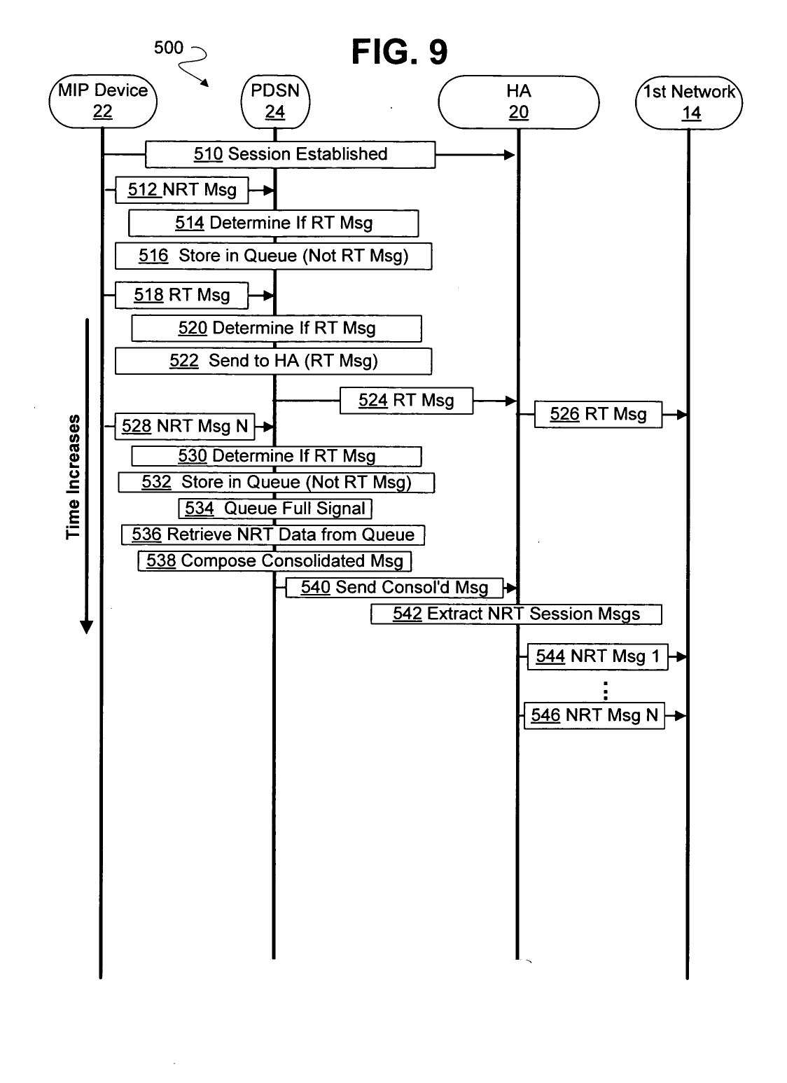

FIG. 9 is a flowchart 500 illustrating another embodiment of messages sent within the system 2. Initially, the mobile IP device 22 establishes a session through the packet data serving node 24 to the home agent 20, as shown in step 510. Subsequently, a non-real-time message arrives at the packet data serving node 24 from the mobile IP device 22. The packet data serving node 24 receives the message through the packet data serving node radio access network interface 102 over the first packet data serving node network 104 and determines if the message is a real-time message or non-real-time message, as shown in step 514. Since the message 512 is a non-real-time message, the packet data serving node processor subsystem 100 stores the message in the packet data serving node queue 112. For this example, the packet data serving node queue 112 holds a quantity of 1024 messages, the packet data serving node queue 112 already has 1022 messages previously stored and un-retrieved, and the message stored in step 516 is the 1023rd message stored in the packet data serving node queue 112.

Later, a real-time data message arrives in the packet data serving node 24 from the mobile IP device 22, as shown in step 518. The packet data serving node processor subsystem 100 receives the message and determines if the message is a real-time message, as shown in step 520. Since the message is a real-time message, the packet data serving node processor subsystem 100 sends the message to the home agent 20, as shown in step 522 and 524. The home agent 20 receives and forwards the message from step 524 to the destination device on the private IP network 8 via the secure first network 12, the non-secure second network 14, or the Internet 8, as shown in step 526.

Subsequently, another non-real-time message is received by the home agent 20 from the mobile IP device 22, as shown in step 528. The packet data serving node processor subsystem 100 receives the message and determines if the message is a real-time message, as shown in step 530. Since the message from step 528 is a non-real-time message, the packet data serving node processor subsystem 100 stores the message in the packet data serving node queue 112. The message is the 1024th non-real-time message stored in the packet data serving node queue 112. Consequently, the packet data serving node queue 112 is now full. The packet data serving node queue 112 alerts the packet data serving node processor subsystem 100 of the queue full condition via the packet data serving node queue full signal 116, as shown in step 534.

The packet data serving node processor subsystem 100 next extracts messages from the packet data serving node queue 112 in a first-in-first-out manner (i.e., the oldest message stored is retrieved first, then the second oldest message stored is retrieved, etc.), as shown in step 536. The packet data serving node processor subsystem 100 also retrieves the packet data serving node maximum payload value 118 from the packet data serving node memory 108 and composes a consolidated message 220, as shown in step 538, ensuring that the consolidated payload 222 of the consolidated message does not exceed the size specified by the packet data serving node maximum payload value 118. For this example, the packet data serving node maximum payload value 118 is 1024-bytes. The consolidated message 220 is addressed and sent to the home agent 20, as shown in step 540. The packet data serving node processor subsystem 100 continues extracting messages from the queue 112 and composes consolidated messages that do not exceed 1024-bytes that are sent to the home agent 20 until the packet data serving node queue 112 is empty.

The consolidated message from step 540 will arrive at the home agent first local network interface 72 from the first local home network 28. The home agent processor system 70 retrieves the message from the home agent first local network interface 72 across the first home agent network 74. The home agent processor subsystem 70 then extracts the individual session messages 210 (i.e., MSG 1 through MSG N) from the consolidated payload 222 of the consolidated message 220, as shown in step 542. The home agent processor subsystem 70 then sends the extracted messages 210 (e.g., messages 1 through N) to their destination. Messages destined for the private IP network 8 are sent across the fourth home agent network 99 through the home agent Internet interface 97 and across the third network 16. Messages destined for the Internet 10 are sent across the fourth home agent network 99 through the home agent private IP network interface 98 and across either the secure first network 12 or the non-secure second network 14, as shown in step 544 and step 546. Each such consolidated message 220 received by the home agent 20 is processed in a similar manner.

Within the example described in FIG. 9, the non-real-time messages are each assumed to be small enough such that the messages can be stored in the packet data serving node queue 112 without filling up the queue themselves. However, since the queue of packets is emptied based on number of bytes or stored packets, if the total length of all the packets in the queue reach a certain limit, then the packets are bundled and sent. As a result, if a single non-real-time packet is large enough, the packet may not be stored at all, and may just be sent immediately, for example.

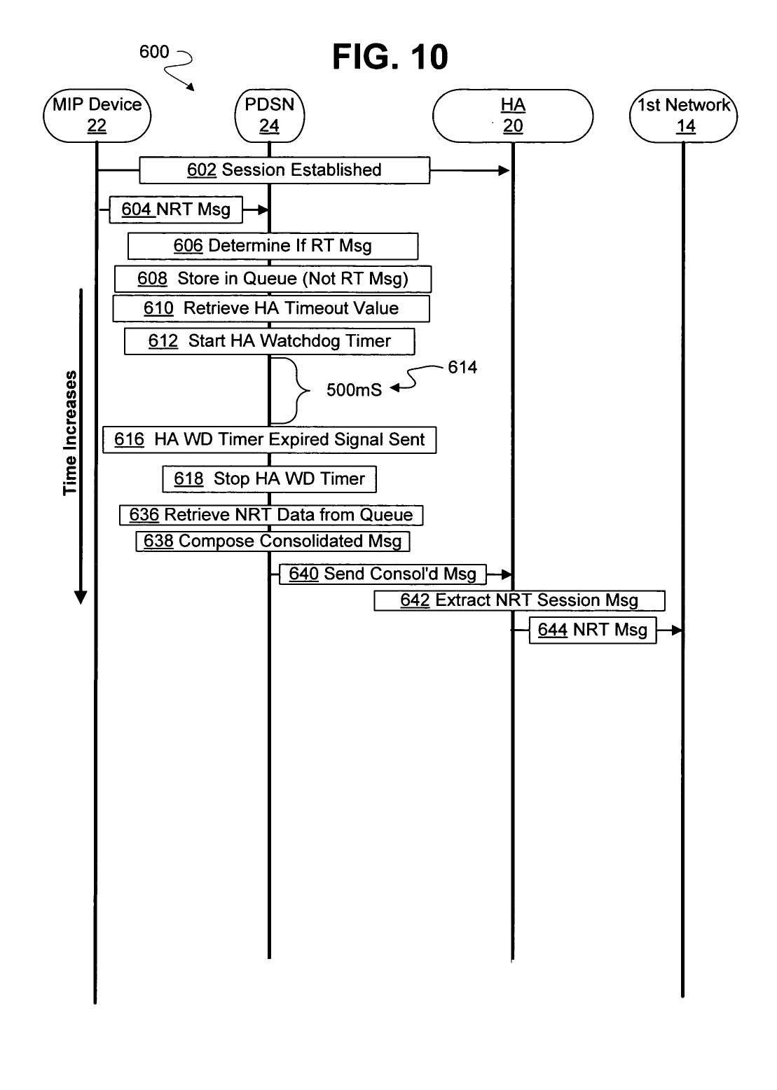

FIG. 10 is a flowchart 600 illustrating another embodiment of messages sent within the system 2. After the mobile IP device 22 establishes a session through the packet data serving node 24 to the home agent 20, as shown in step 602, a non-real-time message arrives at the packet data serving node 24 from the mobile IP device 22, as shown in step 604. The packet data serving node processor subsystem 100 receives the message and determines if the message is a real-time message or non-real-time message, as shown in step 606. For this example, the packet data serving node queue 112 has a capacity of 1024 messages, but currently contains no messages. Since the message from step 604 is a non-real-time message, the packet data serving node processor subsystem 100 stores the message in the packet data serving node queue 112, as shown in step 608. The packet data serving node queue 112 now has one message stored in the queue.

Since the message is the first message stored in the empty packet data serving node queue 112, the packet data serving node processor subsystem 100 programs the packet data serving node watchdog timer 120 with the packet data serving node timeout value 122 by retrieving and sending the packet data serving node timeout value 122 (e.g., 500 mS) to the packet data serving node watchdog timer 120, as shown in step 610. The packet data serving node processor subsystem 100 also commands the packet data serving node watchdog timer 120 to begin timing by sending a “Start Timing” command over the fourth packet data serving node network 124, as shown in step 612. The packet data serving node watchdog timer 120 then begins timing a 500 mS event.

At a time 500 mS later, the packet data serving node watchdog timer 120 expires and sends the packet data serving node watchdog timer expired signal 126 to the packet data serving node processor subsystem 100, as shown in step 616. The packet data serving node processor subsystem 100 sends the packet data serving node watchdog timer 120 a “Stop Timing” command to cause the packet data serving node watchdog timer 120 to halt operation.

The packet data serving node processor subsystem 100 then retrieves messages from the packet data serving node queue 112 in a first-in-first-out manner, as shown in step 636. For this example, only one message has been previously stored in the packet data serving node queue 112, and thus only one message is retrieved from the packet data serving node queue 112. The packet data serving node processor subsystem 100 also retrieves the packet data serving node maximum payload value 118 from the packet data serving node memory 108 and composes a consolidated message 220, as shown in step 638. The packet data serving node processor subsystem 100 uses the packet data serving node maximum payload value 118 to ensure that the consolidated payload 222 does not exceed the size specified by the packet data serving node maximum payload value 118. The consolidated message 220 is addressed and sent to the home agent 20, as shown in step 640. The packet data serving node processor subsystem 100 continues extracting and composing consolidated messages to be sent to the home agent 20 until the packet data serving node queue 112 is empty, for example.

The consolidated message 220 from step 640 will arrive at the home agent processor subsystem 70, which extracts the individual session messages 210, such as MSG 1 through MSG N (i.e., only a MSG 1 exists for this example), from the consolidated payload 222 of the consolidated message 220, as shown in step 642. The home agent processor subsystem 70 then sends the extracted message MSG 1 to its destination, as shown in step 644.

Exemplary embodiments described herein help increase data capacity of a home network by consolidating a large quantity of smaller datagrams into a small quantity of larger datagrams, for example. Through the consolidation of messages, message overhead is reduced due to a reduction in a total number of datagrams traveling through a home network, which in turn, provides capacity for more datagrams.

Home agent and packet data serving node processing power can be conserved by decreasing the need to parse and process a large number of incoming and outgoing smaller datagrams. The home agent and packet data serving nodes can use the recovered processing power to serve other network functions. Consequently, fewer home agents may be required to accomplish the same amount of data transfer, for example.

Real-time data application Quality of Service (QoS) and response time can also be improved as the non-real-time datagrams are temporarily removed from the system when queued, producing a higher ratio of real-time datagrams to non-real-time datagrams be transferred. The temporary decrease in non-real-time data datagrams increases the available system bandwidth for real-time datagrams by improving CSMA/CD access times and decreasing real-time datagram latency.

Exemplary embodiments have been described herein. It is to be understood, however, that changes and modifications can be made without departing from the true scope and spirit of the present invention. Other embodiments of the present invention, of course, will be apparent to those of ordinary skill in the art upon their review of the detailed description. No one embodiment should be deemed to be controlling, as all embodiments of the present invention are deemed to be covered by the appended claims. Certainly, the invention can be interpreted to encompass technological improvements not yet developed and/or available to the public. The following claims and their equivalents, which are to be interpreted in light of the foregoing specification, define the true scope and spirit of the invention.

What is claimed is:

1. A method for consolidating messages in a network comprising:
receiving session messages;
identifying whether the received session messages are non-real-time messages or real-time messages; and
prioritizing forwarding of the real-time messages ahead of the non-real-time messages to their respective destinations.

2. The method of claim 1, wherein prioritizing forwarding of the real-time messages ahead of the non-real-time messages to their respective destinations comprises:
forwarding the real-time messages to their respective destinations upon receipt of the real-time messages; and
storing the non-real-time messages in a queue.

3. The method of claim 2, further comprising forwarding the non-real-time messages to their respective destinations upon expiration of a timer.

4. The method of claim 2, further comprising forwarding the non-real-time messages to their respective destinations once a given amount of data comprising the non-real-time messages has been stored in the queue.

5. The method of claim 2, further comprising:
consolidating stored non-real-time messages into a consolidated message; and
forwarding the consolidated message to a mobility agent.

6. The method of claim 5, further comprising:
receiving the consolidated message at the mobility agent;
extracting the non-real-time messages from the consolidated message; and
forwarding the extracted non-real-time messages to their respective destinations.

7. A method for consolidating mobile IP messages in a network comprising:
receiving session messages from a device at a first mobility agent;
identifying whether the received session messages are non-real-time messages or real-time messages;
transmitting identified real-time session messages to a second mobility agent; and
storing identified non-real-time session messages in a queue within the first mobility agent.

8. The method of claim 7, further comprising:
retrieving a quantity of identified non-real-time messages from the queue within the first mobility agent; and
composing a consolidated payload message including the quantity of identified non-real-time messages.

9. The method of claim 8, wherein the consolidated payload message includes a General Routing Encapsulation (GRE) header coupled to payload of the consolidated payload message and an IP header including a destination address coupled to the GRE header, wherein the GRE header identifies the consolidated payload message as a consolidated message.

10. The method of claim 8, further comprising:
receiving a first mobility agent queue full signal prompting retrieval of the quantity of the identified non-real-time messages from the queue;
retrieving a stored maximum payload value in response to the first mobility agent queue full signal; and
composing the consolidated payload message according to the stored maximum payload value.

11. The method of claim 8, further comprising:
appending a consolidation header to the consolidated payload message and appending an IP header to the combination thereof; and
sending the consolidated payload message to the second mobility agent.

12. The method of claim 11, further comprising:
receiving the consolidated message at the second mobility agent;
extracting the identified non-real-time session messages from the consolidated payload message; and
sending the identified non-real-time session messages to their destinations.

13. The method of claim 7, wherein the first mobility agent and the second mobility agent are selected from the group consisting of a home agent and a packet data serving node.

14. The method of claim 8, further comprising:
starting a watchdog timer after storing the identified non-real-time session messages in the queue within the first mobility agent;
when the watchdog timer has expired, composing a consolidated payload message including stored non-real-time session messages; and
sending the consolidated payload message to the second mobility agent.

15. A mobility agent comprising:
a network interface for receiving session messages from a mobile IP device;
a queue for storing received session messages;
memory; and
a processor coupled to the network interface and operable to execute functions stored in the memory to:
determine if the received session messages are real-time or non-real-time messages;
forward the received session messages to their respective destination if the received session messages include real-time-data; and
store the received session messages in the queue if the received session messages include non-real-time data.

16. The mobility agent of claim 15, wherein the processor is further operable to execute functions stored in the memory to:
retrieve stored non-real-time session messages from the queue when the queue is full;
consolidate the stored retrieved non-real-time messages into larger payloads;
form consolidated messages including the consolidated payloads; and
send the consolidated messages to their respective destinations.

17. The mobility agent of claim 15, further comprising a watchdog timer coupled to the processor, wherein the processor starts the watchdog timer to time an event when a first non-real-time message is stored in the queue.

18. The mobility agent of claim 17, wherein the processor is further operable to execute functions stored in the memory to:
upon expiration of the watchdog timer, retrieve messages stored in the queue;
consolidate the retrieved messages into larger payloads;
form consolidated messages including the consolidated payloads; and
send the consolidated messages to their respective destinations.

19. The mobility agent of claim 15, wherein the processor is further operable to execute functions stored in the memory to:
receive a consolidated message from the network interface;
extract a consolidated payload from the consolidated message;
identify individual messages within the consolidated payload; and
forward each individual message to its respective destination as specified by a header within each individual message.

20. The mobility agent of claim 15, wherein the mobility agent is selected from the group consisting of a home agent and a packet data serving node.
